(19) United States
(12) Patent Application Publication
(10) Pub. No.: US 2024/0264759 A1
(43) Pub. Date: Aug. 8, 2024

(54) METHOD AND APPARATUS TO PERFORM MEMORY RECONFIGURATION WITHOUT A SYSTEM REBOOT

(71) Applicant: Intel Corporation, Santa Clara, CA (US)

(72) Inventors: Anand K. ENAMANDRAM, Folsom, CA (US); Kerry VANDER KAMP, Hillsboro, OR (US); Mahesh S. NATU, Folsom, CA (US); Robert A. BRANCH, Portland, OR (US)

(21) Appl. No.: 18/622,005

(22) Filed: Mar. 29, 2024

(51) Int. Cl. G06F 3/06

(52) U.S. Cl. CPC G06F 3/0647; G06F 3/0604; G06F 3/0683

(57) ABSTRACT

A Cloud Service Provider reconfigures a memory subsystem during routine operation, while minimizing the amount of time a server is not online. Server downtime is reduced by offloading reconfiguration of system memory to the operating system with platform assistance. The operating system enumerates potential memory configurations of the memory subsystem with associated performance characteristics in an abstracted manner and performs reconfiguration of the memory subsystem without a cold reset. When reconfiguration of the memory subsystem is deemed necessary by the operating system, the operating system examines the enumerated memory subsystem configurations provided by system firmware. After selecting the memory subsystem configuration, the operating system initiates a reconfiguration process. The reconfiguration process saves any existing memory context to an auxiliary device, requests system firmware to perform the memory subsystem reconfiguration, and restores the existing memory context from the auxiliary device after the memory subsystem reconfiguration has been completed.

### BACKGROUND

Cloud computing provides access to servers, storage, databases, and a broad set of application services over the Internet. A cloud service provider offers cloud services such as compute, network and storage services and business applications that are hosted in servers in one or more data centers that can be accessed by companies or individuals over the Internet. Hyperscale cloud-service providers typically have hundreds of thousands of servers. Each server in a hyperscale cloud includes storage devices to store user data, for example, user data for business intelligence, data mining, analytics, social media and micro-services. The cloud service provider generates revenue from companies and individuals (also referred to as tenants) that use the cloud services.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 is a simplified diagram of at least one embodiment of a data center for executing workloads with disaggregated resources;

FIG. 2 is a simplified diagram of at least one embodiment of a pod that may be included in a data center;

FIG. 3 is a simplified block diagram of at least one embodiment of a top side of a node;

FIG. 4 is a simplified block diagram of at least one embodiment of a bottom side of a node;

FIG. 5 is a simplified block diagram of at least one embodiment of a compute node;

FIG. 6 is a simplified block diagram of at least one embodiment of an accelerator node usable in a data center;

FIG. 7 is a simplified block diagram of at least one embodiment of a storage node usable in a data center;

FIG. 8 is a simplified block diagram of at least one embodiment of a memory node usable in a data center;

FIG. 9 depicts a system for executing one or more workloads;

FIG. 10 depicts an example system;

FIG. 11 shows an example system;

FIG. 12 is a block diagram of an embodiment of the system described in conjunction with FIG. 9;

FIG. 13 illustrates an embodiment of a System Resource Affinity Table (SRAT) in an ACPI SRAT in tables in FIG. 12;

FIG. 14 illustrates an embodiment of the flags field in the System Resource Affinity Table (SRAT) in the ACPI SRAT in FIG. 13; and

FIG. 15 is a flowgraph illustrating the use of the ACPI System Resource Affinity Table (SRAT) to offload reconfiguration of system memory to the operating system with platform/firmware assistance.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined only as set forth in the accompanying claims.

### DESCRIPTION OF EMBODIMENTS

The Cloud Service Provider (CSP) typically offers different tiers of Virtual Machines (VMs) as part of the service offerings. For example, servers may be classified into pools: a general purpose (“GP”) pool, a trusted domain (“TD”) pool that runs secure VM's, and a pool with advanced memory capacity (High Memory pool). While operating a large data center with different pools some server instances may need to be reclassified from one pool to another pool for business reasons under certain scenarios. For example, a TD instance may need to be migrated to a GP instance or vice versa. Such migration may require that the processor(s) and/or memory device be reconfigured to match the targeted pool.

Typically, nodes are reclassified by manually choosing a memory configuration, triggering a cold reset of the data server and rebooting the server to the desired target memory configuration. However, this approach is very disruptive to currently active VM's and results in lost server uptime (the amount of time a service or server is online) due to the cold reset of the server. Furthermore, this approach does not meet the stringent server uptime requirements of Cloud Service Providers.

The Cloud Service Provider often needs to reconfigure the memory subsystem during routine operation, while minimizing any downtime (the amount of time a server is not online). Reconfiguration of the memory subsystem in a server typically requires a cold reset of the server which results in an increase in downtime and loss of performance for the Cloud Service Provider. Furthermore, because each server in a data center may implement its memory subsystem uniquely, the Cloud Service Provider operating system (OS) cannot dynamically enumerate all possible memory configurations and the performance characteristics of each memory configuration.

During a cold reboot, the system is shutdown, platform settings such as hard/soft straps, Unified Extensible Firmware Interface (UEFI) firmware setup knobs are modified for the requested system configuration and the system is rebooted. This results in reducing the server uptime resulting in loss of performance and typically requires manual intervention. UEFI is a specification that defines the architecture of platform firmware used for booting computer hardware and its interface for interaction with the operating system.

Instead of performing a cold reboot, a system management interrupt (SMI) can be injected to allow the Unified Extensible Firmware Interface (UEFI) firmware to reprogram the Silicon/Platform to match the desired target configuration. The use of the system management interrupt (SMI) introduces significant platform complexity to coordinate activity of various agents across the system. Furthermore, the Operating System (OS)/Virtual Memory Manager (VMM) has little control over the timing of such events. For example, if a System Management Interrupt is triggered when the operating system has scheduled multiple jobs and is operating at its peak load, the loss of performance could be significant.

In an embodiment, server downtime is reduced by offloading the reconfiguration of system memory to the operating system with platform/firmware assistance. The operating system enumerates different potential memory configurations of the memory subsystem along with associated performance characteristics in an abstracted manner and performs the reconfiguration of the memory subsystem without a cold reset.

When reconfiguration of the memory subsystem is deemed necessary by the operating system kernel, the operating system kernel examines the enumerated potential memory subsystem configurations provided by system firmware. Each possible memory subsystem configuration includes performance characteristics (for example, latency and bandwidth information). The performance characteristics allow the operating system kernel to make an informed choice to select a memory subsystem configuration.

After selecting the memory subsystem configuration, the operating system kernel initiates the reconfiguration process.

The reconfiguration process first saves any existing memory context to an auxiliary device, requests system firmware to perform the memory subsystem reconfiguration, and restores the existing memory context from the auxiliary device after the memory subsystem reconfiguration has been completed.

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

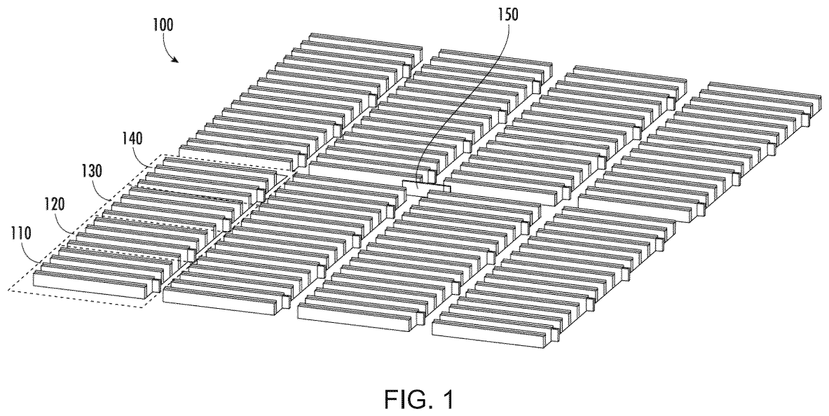

FIG. 1 depicts a data center in which disaggregated resources may cooperatively execute one or more workloads (e.g., applications on behalf of customers) that includes multiple pods 110, 120, 130, 140, a pod being or including one or more rows of racks. Of course, although data center 100 is shown with multiple pods, in some embodiments, the data center 100 may be embodied as a single pod. As described in more detail herein, each rack houses multiple nodes, some of which may be equipped with one or more type of resources (e.g., memory devices, data storage devices, accelerator devices, general purpose processors). Resources can be logically coupled to form a composed node or composite node, which can act as, for example, a server to perform a job, workload or microservices. In the illustrative embodiment, the nodes in each pod 110, 120, 130, 140 are connected to multiple pod switches (e.g., switches that route data communications to and from nodes within the pod). The pod switches, in turn, connect with spine switches 150 that switch communications among pods (e.g., the pods 110, 120, 130, 140) in the data center 100. In some embodiments, the nodes may be connected with a fabric using Intel® Omni-Path technology. In other embodiments, the nodes may be connected with other fabrics, such as InfiniBand or Ethernet or PCI Express or direct optical interconnect. As described in more detail herein, resources within nodes in the data center 100 may be allocated to a group (referred to herein as a “managed node”) containing resources from one or more nodes to be collectively utilized in the execution of a workload. The workload can execute as if the resources belonging to the managed node were located on the same node. The resources in a managed node may belong to nodes belonging to different racks, and even to different pods 110, 120, 130, 140. As such, some resources of a single node may be allocated to one managed node while other resources of the same node are allocated to a different managed node (e.g., one processor assigned to one managed node and another processor of the same node assigned to a different managed node).

A data center comprising disaggregated resources, such as data center 100, can be used in a wide variety of contexts, such as enterprise, government, cloud service provider, and communications service provider (e.g., Telcos), as well in a wide variety of sizes, from cloud service provider mega-data centers that consume over 60,000 sq. ft. to single- or multi-rack installations for use in base stations.

The disaggregation of resources to nodes comprised predominantly of a single type of resource (e.g., compute nodes comprising primarily compute resources, memory nodes containing primarily memory resources), and the selective allocation and deallocation of the disaggregated resources to form a managed node assigned to execute a workload improves the operation and resource usage of the data center 100 relative to typical data centers comprised of hyperconverged servers containing compute, memory, storage and perhaps additional resources in a single chassis. For example, because nodes predominantly contain resources of a particular type, resources of a given type can be upgraded independently of other resources. Additionally, because different resource types (processors, storage, accelerators, etc.) typically have different refresh rates, greater resource utilization and reduced total cost of ownership may be achieved. For example, a data center operator can upgrade the processors throughout their facility by only swapping out the compute nodes. In such a case, accelerator and storage resources may not be contemporaneously upgraded and, rather, may be allowed to continue operating until those resources are scheduled for their own refresh. Resource utilization may also increase. For example, if managed nodes are composed based on requirements of the workloads that will be running on them, resources within a node are more likely to be fully utilized. Such utilization may allow for more managed nodes to run in a data center with a given set of resources, or for a data center expected to run a given set of workloads, to be built using fewer resources.

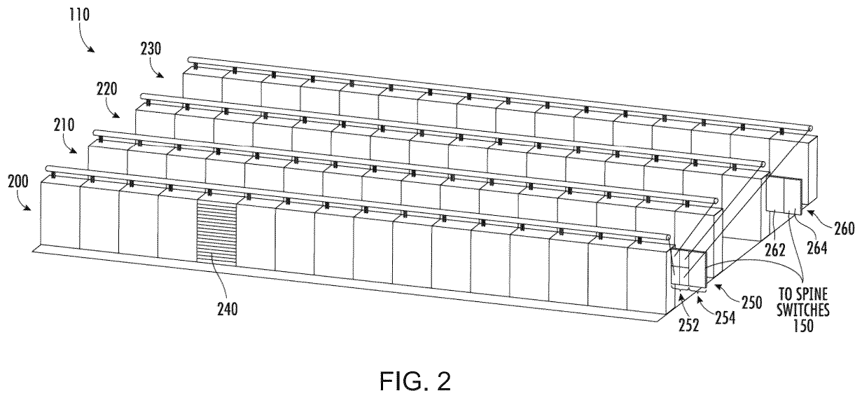

FIG. 2 depicts a pod. A pod can include a set of rows 200, 210, 220, 230 of racks 240. Each rack 240 may house multiple nodes (e.g., sixteen nodes) and provide power and data connections to the housed nodes, as described in more detail herein. In the illustrative embodiment, the racks in each row 200, 210, 220, 230 are connected to multiple pod switches 250, 260. The pod switch 250 includes a set of ports 252 to which the nodes of the racks of the pod 110 are connected and another set of ports 254 that connect the pod 110 to the spine switches 150 to provide connectivity to other pods in the data center 100. Similarly, the pod switch 260 includes a set of ports 262 to which the nodes of the racks of the pod 110 are connected and a set of ports 264 that connect the pod 110 to the spine switches 150. As such, the use of the pair of switches 250, 260 provides an amount of redundancy to the pod 110. For example, if either of the switches 250, 260 fails, the nodes in the pod 110 may still maintain data communication with the remainder of the data center 100 (e.g., nodes of other pods) through the other switch 250, 260. Furthermore, in the illustrative embodiment, the switches 150, 250, 260 may be embodied as dual-mode optical switches, capable of routing both Ethernet protocol communications carrying Internet Protocol (IP) packets and communications according to a second, high-performance link-layer protocol (e.g., PCI Express or Compute Express Link) via optical signaling media of an optical fabric.

It should be appreciated that each of the other pods 120, 130, 140 (as well as any additional pods of the data center 100) may be similarly structured as, and have components similar to, the pod 110 shown in and described in regard to FIG. 2 (e.g., each pod may have rows of racks housing multiple nodes as described above). Additionally, while two pod switches 250, 260 are shown, it should be understood that in other embodiments, each pod 110, 120, 130, 140 may be connected to a different number of pod switches, providing even more failover capacity. Of course, in other embodiments, pods may be arranged differently than the rows-of-racks configuration shown in FIGS. 1-2. For example, a pod may be embodied as multiple sets of racks in which each set of racks is arranged radially, e.g., the racks are equidistant from a center switch.

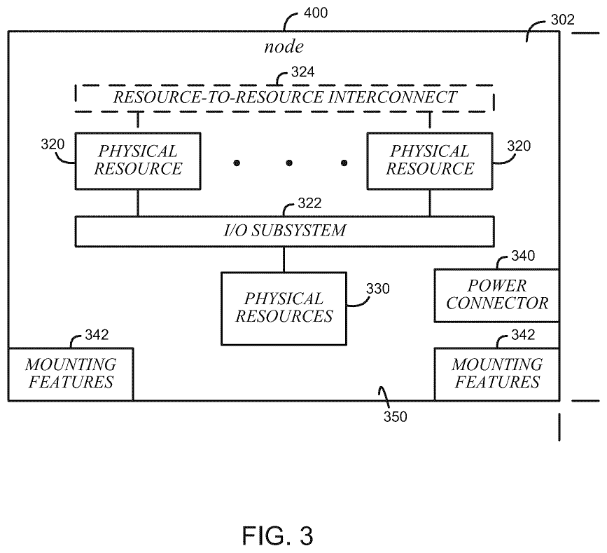

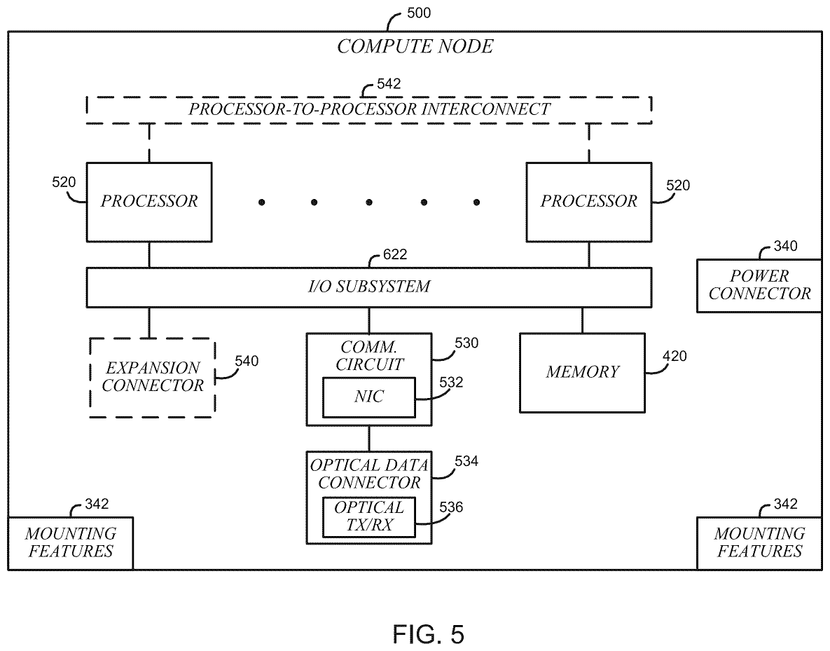

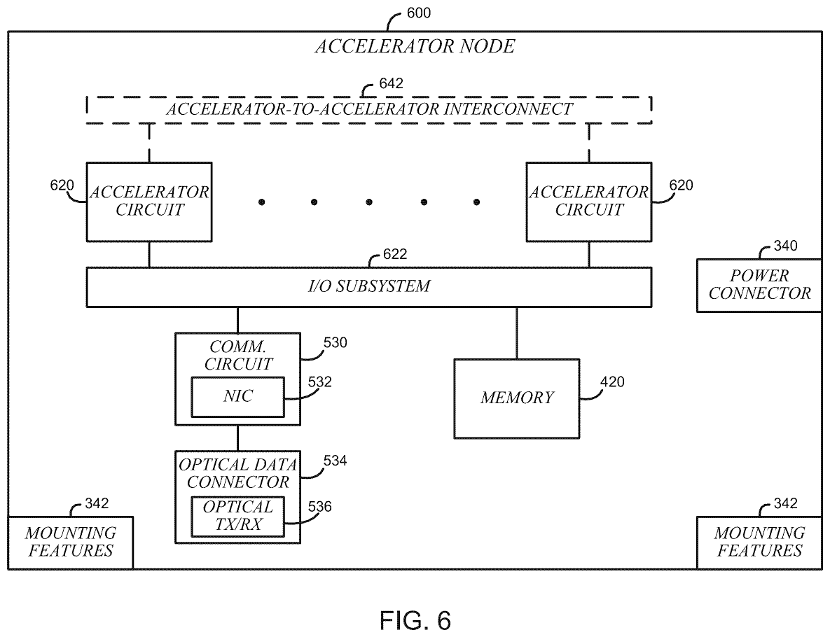

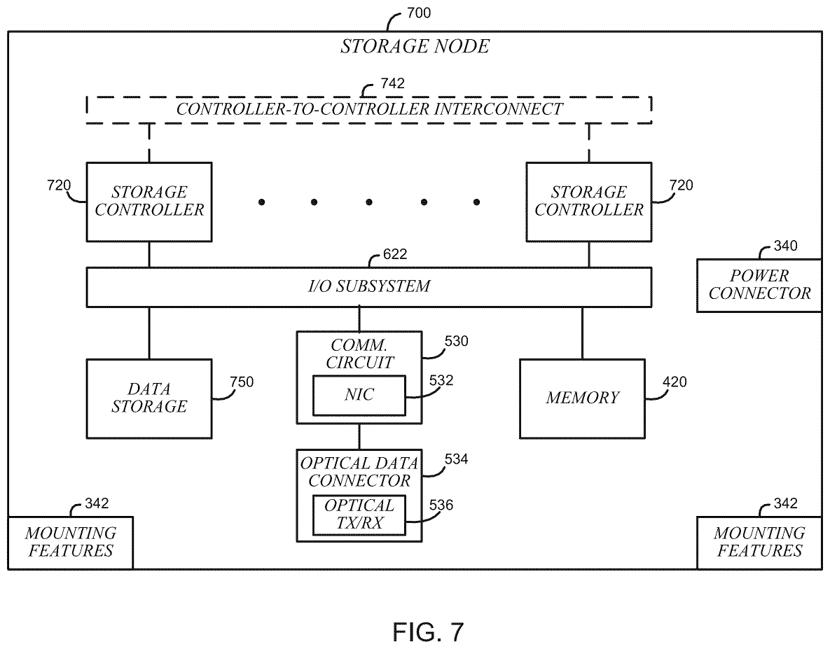

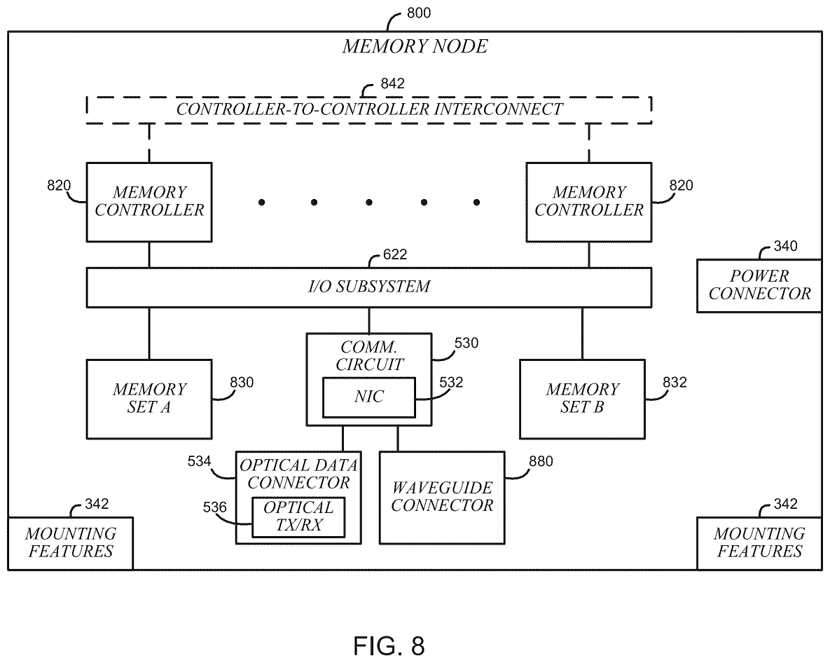

Referring now to FIG. 3, node 400, in the illustrative embodiment, is configured to be mounted in a corresponding rack 240 of the data center 100 as discussed above. In some embodiments, each node 400 may be optimized or otherwise configured for performing particular tasks, such as compute tasks, acceleration tasks, data storage tasks, etc. For example, the node 400 may be embodied as a compute node 500 as discussed below in regard to FIG. 5, an accelerator node 600 as discussed below in regard to FIG. 6, a storage node 700 as discussed below in regard to FIG. 7, or as a node optimized or otherwise configured to perform other specialized tasks, such as a memory node 800, discussed below in regard to FIG. 8. Each rack 240 may contain one or more nodes of a single or multiple node types—compute, storage, accelerator, memory, or others.

As discussed above, the illustrative node 400 includes a circuit board substrate 302, which supports various physical resources (e.g., electrical components) mounted thereon.

As discussed above, the illustrative node 400 includes one or more physical resources 320 mounted to a top side 350 of the circuit board substrate 302. Although two physical resources 320 are shown in FIG. 3, it should be appreciated that the node 400 may include one, two, or more physical resources 320 in other embodiments. The physical resources 320 may be embodied as any type of processor, controller, or other compute circuit capable of performing various tasks such as compute functions and/or controlling the functions of the node 400 depending on, for example, the type or intended functionality of the node 400. For example, as discussed in more detail below, the physical resources 320 may be embodied as high-performance processors in embodiments in which the node 400 is embodied as a compute node, as accelerator co-processors or circuits in embodiments in which the node 400 is embodied as an accelerator node, storage controllers in embodiments in which the node 400 is embodied as a storage node, or a set of memory devices in embodiments in which the node 400 is embodied as a memory node.

The node 400 also includes one or more additional physical resources 330 mounted to the top side 350 of the circuit board substrate 302. In the illustrative embodiment, the additional physical resources include a network interface controller (NIC) as discussed in more detail below. Of course, depending on the type and functionality of the node 400, the physical resources 330 may include additional or other electrical components, circuits, and/or devices in other embodiments.

The physical resources 320 can be communicatively coupled to the physical resources 330 via an input/output (I/O) subsystem 322. The I/O subsystem 322 may be embodied as circuitry and/or components to facilitate input/output operations with the physical resources 320, the physical resources 330, and/or other components of the node 400. For example, the I/O subsystem 322 may be embodied as, or otherwise include, memory controller hubs, input/output control hubs, integrated sensor hubs, firmware devices, communication links (e.g., point-to-point links, bus links, wires, cables, waveguides, light guides, printed circuit board traces, etc.), and/or other components and subsystems to facilitate the input/output operations.

In some embodiments, the node 400 may also include a resource-to-resource interconnect 324. The resource-to-resource interconnect 324 may be embodied as any type of communication interconnect capable of facilitating resource-to-resource communications. In the illustrative embodiment, the resource-to-resource interconnect 324 is embodied as a high-speed point-to-point interconnect (e.g., faster than the I/O subsystem 322). For example, the resource-to-resource interconnect 324 may be embodied as a QuickPath Interconnect (QPI), an UltraPath Interconnect (UPI), PCI express (PCIe), or other high-speed point-to-point interconnect dedicated to resource-to-resource communications.

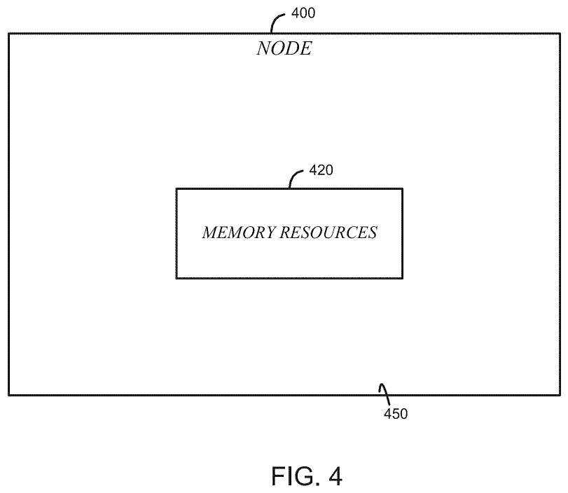

The node 400 also includes a power connector 340 configured to mate with a corresponding power connector of the rack 240 when the node 400 is mounted in the corresponding rack 240. The node 400 receives power from a power supply of the rack 240 via the power connector 340 to supply power to the various electrical components of the node 400. That is, the node 400 does not include any local power supply (e.g., an on-board power supply) to provide power to the electrical components of the node 400. The exclusion of a local or on-board power supply facilitates the reduction in the overall footprint of the circuit board substrate 302, which may increase the thermal cooling characteristics of the various electrical components mounted on the circuit board substrate 302 as discussed above. In some embodiments, voltage regulators are placed on a bottom side 450 (see FIG. 4) of the circuit board substrate 302 directly opposite of the processors 520 (see FIG. 5), and power is routed from the voltage regulators to the processors 520 by vias extending through the circuit board substrate 302. Such a configuration provides an increased thermal budget, additional current and/or voltage, and better voltage control relative to typical printed circuit boards in which processor power is delivered from a voltage regulator, in part, by printed circuit traces.

In some embodiments, the node 400 may also include mounting features 342 configured to mate with a mounting arm, or other structure, of a robot to facilitate the placement of the node 400 in a rack 240 by the robot. The mounting features 342 may be embodied as any type of physical structures that allow the robot to grasp the node 400 without damaging the circuit board substrate 302 or the electrical components mounted thereto. For example, in some embodiments, the mounting features 342 may be embodied as non-conductive pads attached to the circuit board substrate 302. In other embodiments, the mounting features may be embodied as brackets, braces, or other similar structures attached to the circuit board substrate 302. The particular number, shape, size, and/or make-up of the mounting feature 342 may depend on the design of the robot configured to manage the node 400.

Referring now to FIG. 4, in addition to the physical resources 330 mounted on the top side 350 of the circuit board substrate 302, the node 400 also includes one or more memory devices 420 mounted to a bottom side 450 of the circuit board substrate 302. That is, the circuit board substrate 302 can be embodied as a double-sided circuit board. The physical resources 320 can be communicatively coupled to memory devices 420 via the I/O subsystem 322. For example, the physical resources 320 and the memory devices 420 may be communicatively coupled by one or more vias extending through the circuit board substrate 302. A physical resource 320 may be communicatively coupled to a different set of one or more memory devices 420 in some embodiments. Alternatively, in other embodiments, each physical resource 320 may be communicatively coupled to each memory device 420.

The memory devices 420 may be embodied as any type of memory device capable of storing data for the physical resources 320 during operation of the node 400, such as any type of volatile (e.g., dynamic random access memory (DRAM), etc.) or non-volatile memory.

Volatile memory is memory whose state (and therefore the data stored in it) is indeterminate if power is interrupted to the device. Dynamic volatile memory requires refreshing the data stored in the device to maintain state. One example of dynamic volatile memory includes DRAM (Dynamic Random Access Memory), or some variant such as Synchronous Dynamic Random Access Memory (SDRAM). A memory subsystem as described herein may be compatible with a number of memory technologies, such as DDR3 (Double Data Rate version 3) JESD79-3F, originally published by JEDEC (Joint Electronic Device Engineering Council) in June 2007. DDR4 (DDR version 4), JESD209-4D, originally published in September 2012, DDR5 (DDR version 5), JESD79-5B, originally published in June 2021, DDR6 (DDR version 6), currently in discussion by JEDEC, LPDDR3 (Low Power DDR version 3, JESD209-3C, originally published in August 2015, LPDDR4 (LPDDR version 4, JESD209-4D, originally published in June 2021), LPDDR5 (LPDDR version 5, JESD209-5B, originally published in June 2021), WIO2 (Wide Input/Output version 2), JESD229-2, originally published in August 2014, HBM (High Bandwidth Memory), JESD235B, originally published in December 2018, HBM2 (HBM version 2, JESD235D, originally published in March 2021, HBM3 (HBM version 3), JESD238A originally published in January 2023) or HBM4 (HBM version 4), currently in discussion by JEDEC, or others or combinations of memory technologies, and technologies based on derivatives or extensions of such specifications. The JEDEC standards are available at www.jedec.org.

In one embodiment, the memory device is a block addressable memory device, such as those based on NAND or NOR technologies, for example, multi-threshold level NAND flash memory and NOR flash memory. A block can be any size such as but not limited to 2 KB, 4 KB, 5 KB, and so forth. A memory device may also include next-generation nonvolatile devices, such as Intel Optane® memory or other byte addressable write-in-place nonvolatile memory devices, for example, memory devices that use chalcogenide glass, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the die itself and/or to a packaged memory product. In some embodiments, the memory device may comprise a transistor-less stackable cross point architecture in which memory cells sit at the intersection of word lines and bit lines and are individually addressable and in which bit storage is based on a change in bulk resistance.

Referring now to FIG. 5, in some embodiments, the node 400 may be embodied as a compute node 500. The compute node 500 can be configured to perform compute tasks. Of course, as discussed above, the compute node 500 may rely on other nodes, such as acceleration nodes and/or storage nodes, to perform compute tasks.

In the illustrative compute node 500, the physical resources 320 are embodied as processors 520. Although only two processors 520 are shown in FIG. 5, it should be appreciated that the compute node 500 may include additional processors 520 in other embodiments. Illustratively, the processors 520 are embodied as high-performance processors 520 and may be configured to operate at a relatively high power rating.

In some embodiments, the compute node 500 may also include a processor-to-processor interconnect 542. Processor-to-processor interconnect 542 may be embodied as any type of communication interconnect capable of facilitating processor-to-processor interconnect 542 communications. In the illustrative embodiment, the processor-to-processor interconnect 542 is embodied as a high-speed point-to-point interconnect (e.g., faster than the I/O subsystem 322). For example, the processor-to-processor interconnect 542 may be embodied as a QuickPath Interconnect (QPI), an UltraPath Interconnect (UPI), or other high-speed point-to-point interconnect dedicated to processor-to-processor communications (e.g., PCIe or CXL).

The compute node 500 also includes a communication circuit 530. The illustrative communication circuit 530 includes a network interface controller (NIC) 532, which may also be referred to as a host fabric interface (HFI). The NIC 532 may be embodied as, or otherwise include, any type of integrated circuit, discrete circuits, controller chips, chipsets, add-in-boards, daughtercards, network interface cards, or other devices that may be used by the compute node 500 to connect with another compute device (e.g., with other nodes 400). In some embodiments, the NIC 532 may be embodied as part of a system-on-a-chip (SoC) that includes one or more processors, or included on a multichip package that also contains one or more processors. In some embodiments, the NIC 532 may include a local processor (not shown) and/or a local memory (not shown) that are both local to the NIC 532. In such embodiments, the local processor of the NIC 532 may be capable of performing one or more of the functions of the processors 520. Additionally or alternatively, in such embodiments, the local memory of the NIC 532 may be integrated into one or more components of the compute node at the board level, socket level, chip level, and/or other levels. In some examples, a network interface includes a network interface controller or a network interface card. In some examples, a network interface can include one or more of a network interface controller (NIC) 532, a host fabric interface (HFI), a host bus adapter (HBA), network interface connected to a bus or connection (e.g., PCIe, CXL, DDR, and so forth). In some examples, a network interface can be part of a switch or a system-on-chip (SoC).

The communication circuit 530 is communicatively coupled to an optical data connector 534. The optical data connector 534 is configured to mate with a corresponding optical data connector of a rack when the compute node 500 is mounted in the rack. Illustratively, the optical data connector 534 includes a plurality of optical fibers which lead from a mating surface of the optical data connector 534 to an optical transceiver 536. The optical transceiver 536 is configured to convert incoming optical signals from the rack-side optical data connector to electrical signals and to convert electrical signals to outgoing optical signals to the rack-side optical data connector. Although shown as forming part of the optical data connector 534 in the illustrative embodiment, the optical transceiver 536 may form a portion of the communication circuit 530 or even processor 520 in other embodiments.

In some embodiments, the compute node 500 may also include an expansion connector 540. In such embodiments, the expansion connector 540 is configured to mate with a corresponding connector of an expansion circuit board substrate to provide additional physical resources to the compute node 500. The additional physical resources may be used, for example, by the processors 520 during operation of the compute node 500. The expansion circuit board substrate may be substantially similar to the circuit board substrate 302 discussed above and may include various electrical components mounted thereto. The particular electrical components mounted to the expansion circuit board substrate may depend on the intended functionality of the expansion circuit board substrate. For example, the expansion circuit board substrate may provide additional compute resources, memory resources, and/or storage resources. As such, the additional physical resources of the expansion circuit board substrate may include, but is not limited to, processors, memory devices, storage devices, and/or accelerator circuits including, for example, field programmable gate arrays (FPGA), application-specific integrated circuits (ASICs), security co-processors, graphics processing units (GPUs), machine learning circuits, or other specialized processors, controllers, devices, and/or circuits.

Referring now to FIG. 6, in some embodiments, the node 400 may be embodied as an accelerator node 600. The accelerator node 600 is configured to perform specialized compute tasks, such as machine learning, encryption, hashing, or other computational-intensive task. In some embodiments, for example, a compute node 500 may offload tasks to the accelerator node 600 during operation. The accelerator node 600 includes various components similar to components of the node 400 and/or compute node 500, which have been identified in FIG. 6 using the same reference numbers.

In the illustrative accelerator node 600, the physical resources 320 are embodied as accelerator circuits 620. Although only two accelerator circuits 620 are shown in FIG. 6, it should be appreciated that the accelerator node 600 may include additional accelerator circuits 620 in other embodiments. The accelerator circuits 620 may be embodied as any type of processor, co-processor, compute circuit, or other device capable of performing compute or processing operations. For example, the accelerator circuits 620 may be embodied as, for example, central processing units, cores, field programmable gate arrays (FPGA), application-specific integrated circuits (ASICs), programmable control logic (PCL), security co-processors, graphics processing units (GPUs), neuromorphic processor units, quantum computers, machine learning circuits, or other specialized processors, controllers, devices, and/or circuits.

In some embodiments, the accelerator node 600 may also include an accelerator-to-accelerator interconnect 642. Similar to the resource-to-resource interconnect 324 of the node 400 discussed above, the accelerator-to-accelerator interconnect 642 may be embodied as any type of communication interconnect capable of facilitating accelerator-to-accelerator communications. In the illustrative embodiment, the accelerator-to-accelerator interconnect 642 is embodied as a high-speed point-to-point interconnect (e.g., faster than the I/O subsystem 622). For example, the accelerator-to-accelerator interconnect 642 may be embodied as a QuickPath Interconnect (QPI), an UltraPath Interconnect (UPI), or other high-speed point-to-point interconnect dedicated to processor-to-processor communications. In some embodiments, the accelerator circuits 620 may be daisy-chained with a primary accelerator circuit 620 connected to the NIC 532 and memory 420 through the I/O subsystem 322 and a secondary accelerator circuit 620 connected to the NIC 532 and memory 420 through a primary accelerator circuit 620.

Referring now to FIG. 7, in some embodiments, the node 400 may be embodied as a storage node 700. The storage node 700 is configured to store data in a data storage 750 local to the storage node 700. For example, during operation, a compute node 500 or an accelerator node 600 may store and retrieve data from the data storage 750 of the storage node 700. The storage node 700 includes various components similar to components of the node 400 and/or the compute node 500, which have been identified in FIG. 7 using the same reference numbers.

In the illustrative storage node 700, the physical resources 320 are embodied as storage controllers 720. Although only two storage controllers 720 are shown in FIG. 7, it should be appreciated that the storage node 700 may include additional storage controllers 720 in other embodiments. The storage controllers 720 may be embodied as any type of processor, controller, or control circuit capable of controlling the storage and retrieval of data into the data storage 750 based on requests received via the communication circuit 530. In the illustrative embodiment, the storage controllers 720 are embodied as relatively low-power processors or controllers. For example, in some embodiments, the storage controllers 720 may be configured to operate at a power rating of about 75 watts.

In some embodiments, the storage node 700 may also include a controller-to-controller interconnect 742. Similar to the resource-to-resource interconnect 324 of the node 400 discussed above, the controller-to-controller interconnect 742 may be embodied as any type of communication interconnect capable of facilitating controller-to-controller communications. In the illustrative embodiment, the controller-to-controller interconnect 742 is embodied as a high-speed point-to-point interconnect (e.g., faster than the I/O subsystem 622). For example, the controller-to-controller interconnect 742 may be embodied as a QuickPath Interconnect (QPI), an UltraPath Interconnect (UPI), or other high-speed point-to-point interconnect dedicated to processor-to-processor communications.

Referring now to FIG. 8, in some embodiments, the node 400 may be embodied as a memory node 800. The memory node 800 is configured to provide other nodes 400 (e.g., compute nodes 500, accelerator nodes 600, etc.) with access to a pool of memory (e.g., in two or more sets 830, 832 of memory devices 420) local to the storage node 700. For example, during operation, a compute node 500 or an accelerator node 600 may remotely write to and/or read from one or more of the memory sets 830, 832 of the memory node 800 using a logical address space that maps to physical addresses in the memory sets 830, 832.

In the illustrative memory node 800, the physical resources 320 are embodied as memory controllers 820. Although only two memory controllers 820 are shown in FIG. 8, it should be appreciated that the memory node 800 may include additional memory controllers 820 in other embodiments. The memory controllers 820 may be embodied as any type of processor, controller, or control circuit capable of controlling the writing and reading of data into the memory sets 830, 832 based on requests received via the communication circuit 530. In the illustrative embodiment, each memory controller 820 is connected to a corresponding memory set 830, 832 to write to and read from memory devices 420 within the corresponding memory set 830, 832 and enforce any permissions (e.g., read, write, etc.) associated with node 400 that has sent a request to the memory node 800 to perform a memory access operation (e.g., read or write).

In some embodiments, the memory node 800 may also include a controller-to-controller interconnect 842. Similar to the resource-to-resource interconnect 324 of the node 400 discussed above, the controller-to-controller interconnect 842 may be embodied as any type of communication interconnect capable of facilitating controller-to-controller communications. In the illustrative embodiment, the controller-to-controller interconnect 842 is embodied as a high-speed point-to-point interconnect (e.g., faster than the I/O subsystem 622). For example, the controller-to-controller interconnect 842 may be embodied as a QuickPath Interconnect (QPI), an UltraPath Interconnect (UPI), or other high-speed point-to-point interconnect dedicated to processor-to-processor communications. As such, in some embodiments, a memory controller 820 may access, through the controller-to-controller interconnect 842, memory that is within the memory set 832 associated with another memory controller 820. In some embodiments, a scalable memory controller is made of multiple smaller memory controllers, referred to herein as “chiplets”, on a memory node (e.g., the memory node 800). The chiplets may be interconnected (e.g., using EMIB (Embedded Multi-Die Interconnect Bridge)). The combined chiplet memory controller may scale up to a relatively large number of memory controllers and I/O ports, (e.g., up to 16 memory channels). In some embodiments, the memory controllers 820 may implement a memory interleave (e.g., one memory address is mapped to the memory set 830, the next memory address is mapped to the memory set 832, and the third address is mapped to the memory set 830, etc.). The interleaving may be managed within the memory controllers 820, or from CPU sockets (e.g., of the compute node 500) across network links to the memory sets 830, 832, and may improve the latency associated with performing memory access operations as compared to accessing contiguous memory addresses from the same memory device.

Further, in some embodiments, the memory node 800 may be connected to one or more other nodes 400 (e.g., in the same rack 240 or an adjacent rack 240) through a waveguide, using the waveguide connector 880. In the illustrative embodiment, the waveguides are 64 millimeter waveguides that provide 16 Rx (e.g., receive) lanes and 16 Tx (e.g., transmit) lanes. Each lane, in the illustrative embodiment, is either 16 GHz or 32 GHz. In other embodiments, the frequencies may be different. Using a waveguide may provide high throughput access to the memory pool (e.g., the memory sets 830, 832) to another node (e.g., a node 400 in the same rack 240 or an adjacent rack 240 as the memory node 800) without adding to the load on the optical data connector 534.

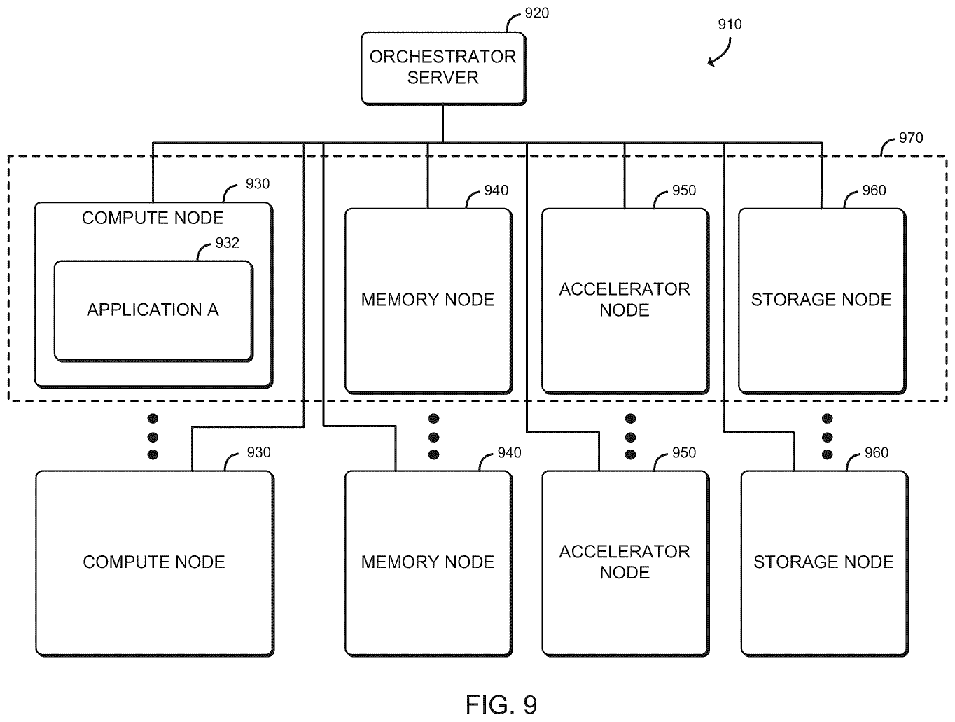

Referring now to FIG. 9, a system for executing one or more workloads (e.g., applications) may be implemented. In the illustrative embodiment, the system 910 includes an orchestrator server 920, which may be embodied as a managed node comprising a compute device (e.g., a processor 520 on a compute node 500) executing management software (e.g., a cloud operating environment, such as OpenStack) that is communicatively coupled to multiple nodes 400 including a large number of compute nodes 930 (e.g., each similar to the compute node 500), memory nodes 940 (e.g., each similar to the memory node 800), accelerator nodes 950 (e.g., each similar to the accelerator node 600), and storage nodes 960 (e.g., each similar to the storage node 700). One or more of the nodes 930, 940, 950, 960 may be grouped into a managed node 970, such as by the orchestrator server 920, to collectively perform a workload (e.g., an application 932 executed in a virtual machine or in a container).

The managed node 970 may be embodied as an assembly of physical resources 320, such as processors 520, memory resources 420, accelerator circuits 620, or data storage 750, from the same or different nodes 400. Physical resources 320 from the same compute node 500 or the same memory node 800 or the same accelerator node 600 or the same storage node 700 can be assigned to a single managed node 970. Alternatively, physical resources 320 from the same node 400 can be assigned to different managed nodes 970. Further, the managed node may be established, defined, or “spun up” by the orchestrator server 920 at the time a workload is to be assigned to the managed node or at any other time, and may exist regardless of whether any workloads are presently assigned to the managed node. In the illustrative embodiment, the orchestrator server 920 may selectively allocate and/or deallocate physical resources 320 from the nodes 400 and/or add or remove one or more nodes 400 from the managed node 970 as a function of quality of service (QOS) targets (e.g., a target throughput, a target latency, a target number instructions per second, etc.) associated with a service level agreement for the workload (e.g., the application 932). In doing so, the orchestrator server 920 may receive telemetry data indicative of performance conditions (e.g., throughput, latency, instructions per second, etc.) in each node 400 of the managed node 970 and compare the telemetry data to the quality of service targets to determine whether the quality of service targets are being satisfied. The orchestrator server 920 may additionally determine whether one or more physical resources may be deallocated from the managed node 970 while still satisfying the QoS targets, thereby freeing up those physical resources for use in another managed node (e.g., to execute a different workload). Alternatively, if the QoS targets are not presently satisfied, the orchestrator server 920 may determine to dynamically allocate additional physical resources to assist in the execution of the workload (e.g., the application 932) while the workload is executing. Similarly, the orchestrator server 920 may determine to dynamically deallocate physical resources from a managed node if the orchestrator server 920 determines that deallocating the physical resource would result in QoS targets still being met.

Additionally, in some embodiments, the orchestrator server 920 may identify trends in the resource utilization of the workload (e.g., the application 932), such as by identifying phases of execution (e.g., time periods in which different operations, each having different resource utilizations characteristics, are performed) of the workload (e.g., the application 932) and pre-emptively identifying available resources in the data center and allocating them to the managed node 970 (e.g., within a predefined time period of the associated phase beginning). In some embodiments, the orchestrator server 920 may model performance based on various latencies and a distribution scheme to place workloads among compute nodes and other resources (e.g., accelerator nodes, memory nodes, storage nodes) in the data center. For example, the orchestrator server 920 may utilize a model that accounts for the performance of resources on the nodes 400 (e.g., FPGA performance, memory access latency, etc.) and the performance (e.g., congestion, latency, bandwidth) of the path through the network to the resource (e.g., FPGA). As such, the orchestrator server 920 may determine which resource(s) should be used with which workloads based on the total latency associated with each potential resource available in the data center 100 (e.g., the latency associated with the performance of the resource itself in addition to the latency associated with the path through the network between the compute node executing the workload and the node 400 on which the resource is located).

In some embodiments, the orchestrator server 920 may generate a map of heat generation in the data center 100 using telemetry data (e.g., temperatures, fan speeds, etc.) reported from the nodes 400 and allocate resources to managed nodes as a function of the map of heat generation and predicted heat generation associated with different workloads, to maintain a target temperature and heat distribution in the data center 100. Additionally or alternatively, in some embodiments, the orchestrator server 920 may organize received telemetry data into a hierarchical model that is indicative of a relationship between the managed nodes (e.g., a spatial relationship such as the physical locations of the resources of the managed nodes within the data center 100 and/or a functional relationship, such as groupings of the managed nodes by the customers the managed nodes provide services for, the types of functions typically performed by the managed nodes, managed nodes that typically share or exchange workloads among each other, etc.). Based on differences in the physical locations and resources in the managed nodes, a given workload may exhibit different resource utilizations (e.g., cause a different internal temperature, use a different percentage of processor or memory capacity) across the resources of different managed nodes. The orchestrator server 920 may determine the differences based on the telemetry data stored in the hierarchical model and factor the differences into a prediction of future resource utilization of a workload if the workload is reassigned from one managed node to another managed node, to accurately balance resource utilization in the data center 100. In some embodiments, the orchestrator server 920 may identify patterns in resource utilization phases of the workloads and use the patterns to predict future resource utilization of the workloads.

To reduce the computational load on the orchestrator server 920 and the data transfer load on the network, in some embodiments, the orchestrator server 920 may send self-test information to the nodes 400 to enable each node 400 to locally (e.g., on the node 400) determine whether telemetry data generated by the node 400 satisfies one or more conditions (e.g., an available capacity that satisfies a predefined threshold, a temperature that satisfies a predefined threshold, etc.). Each node 400 may then report back a simplified result (e.g., yes or no) to the orchestrator server 920, which the orchestrator server 920 may utilize in determining the allocation of resources to managed nodes.

Edge computing, at a general level, refers to the implementation, coordination, and use of computing and resources at locations closer to the “edge” or collection of “edges” of the network. The purpose of this arrangement is to improve total cost of ownership, reduce application and network latency, reduce network backhaul traffic and associated energy consumption, improve service capabilities, and improve compliance with security or data privacy requirements (especially as compared to conventional cloud computing). Components that can perform edge computing operations (“edge nodes”) can reside in whatever location needed by the system architecture or ad hoc service (e.g., in an high performance compute data center or cloud installation; a designated edge node server, an enterprise server, a roadside server, a telecom central office; or a local or peer at-the-edge device being served consuming edge services).

Applications that have been adapted for edge computing include but are not limited to virtualization of traditional network functions (e.g., to operate telecommunications or Internet services) and the introduction of next-generation features and services (e.g., to support 5G network services). Use-cases which are projected to extensively utilize edge computing include connected self-driving cars, surveillance, Internet of Things (IoT) device data analytics, video encoding and analytics, location aware services, device sensing in Smart Cities, among many other network and compute intensive services.

Edge computing may, in some scenarios, offer or host a cloud-like distributed service, to offer orchestration and management for applications and coordinated service instances among many types of storage and compute resources. Edge computing is also expected to be closely integrated with existing use cases and technology developed for IoT and Fog/distributed networking configurations, as endpoint devices, clients, and gateways attempt to access network resources and applications at locations closer to the edge of the network.

The following embodiments generally relate to data processing, service management, resource allocation, compute management, network communication, application partitioning, and communication system implementations, and in particular, to techniques and configurations for adapting various edge computing devices and entities to dynamically support multiple entities (e.g., multiple tenants, users, stakeholders, service instances, applications, etc.) in a distributed edge computing environment.

In the following description, methods, configurations, and related apparatuses are disclosed for various improvements to the configuration and functional capabilities of an edge computing architecture and an implementing edge computing system. These improvements may benefit a variety of use cases, especially those involving multiple stakeholders of the edge computing system-whether in the form of multiple users of a system, multiple tenants on a system, multiple devices or user equipment interacting with a system, multiple services being offered from a system, multiple resources being available or managed within a system, multiple forms of network access being exposed for a system, multiple locations of operation for a system, and the like. Such multi-dimensional aspects and considerations are generally referred to herein as “multi-entity” constraints, with specific discussion of resources managed or orchestrated in multi-tenant and multi-service edge computing configurations.

With the illustrative edge networking systems described below, computing and storage resources are moved closer to the edge of the network (e.g., closer to the clients, endpoint devices, or “things”). By moving the computing and storage resources closer to the device producing or using the data, various latency, compliance, and/or monetary or resource cost constraints may be achievable relative to a standard networked (e.g., cloud computing) system. To do so, in some examples, pools of compute, memory, and/or storage resources may be located in, or otherwise equipped with, local servers, routers, and/or other network equipment. Such local resources facilitate the satisfying of constraints placed on the system. For example, the local compute and storage resources allow an edge system to perform computations in real-time or near real-time, which may be a consideration in low latency user-cases such as autonomous driving, video surveillance, and mobile media consumption. Additionally, these resources will benefit from service management in an edge system which provides the ability to scale and achieve local service-level agreements (SLAs), manage tiered service requirements, and enable local features and functions on a temporary or permanent basis.

An illustrative edge computing system may support and/or provide various services to endpoint devices (e.g., client user equipment (UEs)), each of which may have different requirements or constraints. For example, some services may have priority or quality-of-service (QOS) constraints (e.g., traffic data for autonomous vehicles may have a higher priority than temperature sensor data), reliability and resiliency (e.g., traffic data may require mission-critical reliability, while temperature data may be allowed some error variance), as well as power, cooling, and form-factor constraints. These and other technical constraints may offer significant complexity and technical challenges when applied in the multi-stakeholder setting.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required because edge locations may be unmanned and may even need permissioned access (e.g., when housed in a third-party location). Such issues are magnified in the edge cloud in a multi-tenant, multi-owner, or multi-access setting, where services and applications are requested by many users, especially as network usage dynamically fluctuates and the composition of the multiple stakeholders, use cases, and services changes.

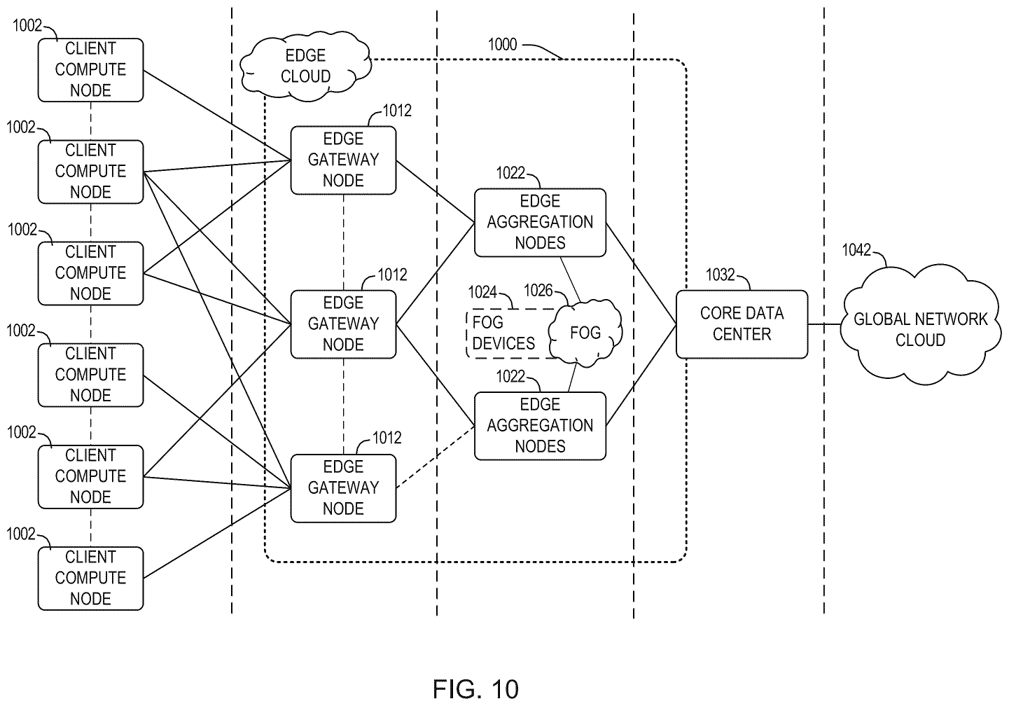

FIG. 10 generically depicts an edge computing system 1000 for providing edge services and applications to multi-stakeholder entities, as distributed among one or more client compute nodes 1002, one or more edge gateway nodes 1012, one or more edge aggregation nodes 1022, one or more core data centers 1032, and a global network cloud 1042, as distributed across layers of the network. The implementation of the edge computing system 1000 may be provided at or on behalf of a telecommunication service provider (“telco”, or “TSP”), internet-of-things service provider, cloud service provider (CSP), enterprise entity, or any other number of entities. Various implementations and configurations of the edge computing system 1000 may be provided dynamically, such as when orchestrated to meet service objectives.

For example, the client compute nodes 1002 are located at an endpoint layer, while the edge gateway nodes 1012 are located at an edge devices layer (local level) of the edge computing system 1000. Additionally, the edge aggregation nodes 1022 (and/or fog devices 1024, if arranged or operated with or among a fog networking configuration 1026) are located at a network access layer (an intermediate level). Fog computing (or “fogging”) generally refers to extensions of cloud computing to the edge of an enterprise's network or to the ability to manage transactions across the cloud/edge landscape, typically in a coordinated distributed or multi-node network. Some forms of fog computing provide the deployment of compute, storage, and networking services between end devices and cloud computing data centers, on behalf of the cloud computing locations. Some forms of fog computing also provide the ability to manage the workload/workflow level services, in terms of the overall transaction, by pushing certain workloads to the edge or to the cloud based on the ability to fulfill the overall service level agreement.

Fog computing in many scenarios provide a decentralized architecture and serves as an extension to cloud computing by collaborating with one or more edge node devices, providing the subsequent amount of localized control, configuration and management, and much more for end devices. Furthermore, Fog computing provides the ability for edge resources to identify similar resources and collaborate in order to create an edge-local cloud which can be used solely or in conjunction with cloud computing in order to complete computing, storage or connectivity related services. Fog computing may also allow the cloud-based services to expand their reach to the edge of a network of devices to offer local and quicker accessibility to edge devices. Thus, some forms of fog computing provide operations that are consistent with edge computing as discussed herein; the edge computing aspects discussed herein are also applicable to fog networks, fogging, and fog configurations. Further, aspects of the edge computing systems discussed herein may be configured as a fog, or aspects of a fog may be integrated into an edge computing architecture.

The core data center 1032 is located at a core network layer (a regional or geographically-central level), while the global network cloud 1042 is located at a cloud data center layer (a national or world-wide layer). The use of “core” is provided as a term for a centralized network location-deeper in the network-which is accessible by multiple edge nodes or components; however, a “core” does not necessarily designate the “center” or the deepest location of the network. Accordingly, the core data center 1032 may be located within, at, or near the edge cloud 1000. Although an illustrative number of client compute nodes 1002, edge gateway nodes 1012, edge aggregation nodes 1022, edge core data centers 1032, global network clouds 1042 are shown in FIG. 10, it should be appreciated that the edge computing system 1000 may include additional devices or systems at each layer. Devices at any layer can be configured as peer nodes to each other and, accordingly, act in a collaborative manner to meet service objectives.

Consistent with the examples provided herein, a client compute node 1002 may be embodied as any type of endpoint component, device, appliance, or other thing capable of communicating as a producer or consumer of data. Further, the label “node” or “device” as used in the edge computing system 1000 does not necessarily mean that such node or device operates in a client or agent/minion/follower role; rather, any of the nodes or devices in the edge computing system 1000 refer to individual entities, nodes, or subsystems which include discrete or connected hardware or software configurations to facilitate or use the edge cloud 1000.

As such, the edge cloud 1000 is formed from network components and functional features operated by and within the edge gateway nodes 1012 and the edge aggregation nodes 1022. The edge cloud 1000 may be embodied as any type of network that provides edge computing and/or storage resources which are proximately located to radio access network (RAN) capable endpoint devices (e.g., mobile computing devices, IoT devices, smart devices, etc.), which are shown in FIG. 10 as the client compute nodes 1002. In other words, the edge cloud 1000 may be envisioned as an “edge” which connects the endpoint devices and traditional network access points that serves as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

In some examples, the edge cloud 1000 may form a portion of or otherwise provide an ingress point into or across a fog networking configuration 1026 (e.g., a network of fog devices 1024, not shown in detail), which may be embodied as a system-level horizontal and distributed architecture that distributes resources and services to perform a specific function. For instance, a coordinated and distributed network of fog devices 1024 may perform computing, storage, control, or networking aspects in the context of an IoT system arrangement. Other networked, aggregated, and distributed functions may exist in the edge cloud 1000 between the core data center 1032 and the client endpoints (e.g., client compute nodes 1002). Some of these are discussed in the following sections in the context of network functions or service virtualization, including the use of virtual edges and virtual services which are orchestrated for multiple stakeholders.

As discussed in more detail below, the edge gateway nodes 1012 and the edge aggregation nodes 1022 cooperate to provide various edge services and security to the client compute nodes 1002. Furthermore, because a client compute node 1002 may be stationary or mobile, a respective edge gateway node 1012 may cooperate with other edge gateway devices to propagate presently provided edge services, relevant service data, and security as the corresponding client compute node 1002 moves about a region. To do so, the edge gateway nodes 1012 and/or edge aggregation nodes 1022 may support multiple tenancy and multiple stakeholder configurations, in which services from (or hosted for) multiple service providers, owners, and multiple consumers may be supported and coordinated across a single or multiple compute devices.

A variety of security approaches may be utilized within the architecture of the edge cloud 1000. In a multi-stakeholder environment, there can be multiple loadable security modules (LSMs) used to provision policies that enforce the stakeholder's interests. Enforcement point environments could support multiple LSMs that apply the combination of loaded LSM policies (e.g., where the most constrained effective policy is applied, such as where if any of A, B or C stakeholders restricts access then access is restricted). Within the edge cloud 1000, each edge entity can provision LSMs that enforce the Edge entity interests. The Cloud entity can provision LSMs that enforce the cloud entity interests. Likewise, the various Fog and IoT network entities can provision LSMs that enforce the Fog entity's interests.

In these examples, services may be considered from the perspective of a transaction, performed against a set of contracts or ingredients, whether considered at an ingredient level or a human-perceivable level. Thus, a user who has a service agreement with a service provider, expects the service to be delivered under terms of the SLA. Although not discussed in detail, the use of the edge computing techniques discussed herein may play roles during the negotiation of the agreement and the measurement of the fulfillment of the agreement (to identify what elements are required by the system to conduct a service, how the system responds to service conditions and changes, and the like).

A “service” is a broad term often applied to various contexts, but in general it refers to a relationship between two entities where one entity offers and performs work for the benefit of another. However, the services delivered from one entity to another must be performed with certain guidelines, which ensure trust between the entities and manage the transaction according to the contract terms and conditions set forth at the beginning, during and end of the service.

The deployment of a multi-stakeholder edge computing system may be arranged and orchestrated to enable the deployment of multiple services and virtual edge instances, among multiple edge nodes and subsystems, for use by multiple tenants and service providers. In a system example applicable to a cloud service provider (CSP), the deployment of an edge computing system may be provided via an “over-the-top” approach, to introduce edge computing nodes as a supplemental tool to cloud computing. In a contrasting system example applicable to a telecommunications service provider (TSP), the deployment of an edge computing system may be provided via a “network-aggregation” approach, to introduce edge computing nodes at locations in which network accesses (from different types of data access networks) are aggregated. FIGS. 9 and 10 contrast these over-the-top and network-aggregation approaches for networking and services in respective edge computing system. However, these over-the-top and network aggregation approaches may be implemented together in a hybrid or merged approach or configuration as suggested in later examples.

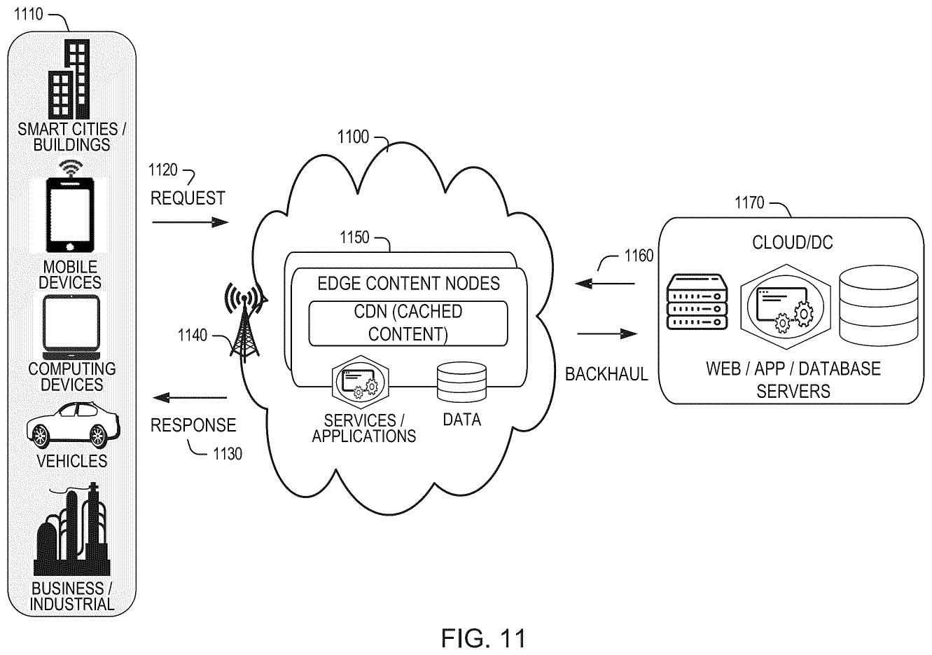

FIG. 11 shows an example where various client endpoints 1110 (in the form of mobile devices, computers, autonomous vehicles, business computing equipment, industrial processing equipment) provide requests 1120 for services or data transactions, and receive responses 1130 for the services or data transactions, to and from the edge cloud 1100 (e.g., via a wireless or wired network 1140). Within the edge cloud 1000, the CSP may deploy various compute and storage resources, such as edge content nodes 1150 to provide cached content from a distributed content delivery network. Other available compute and storage resources available on the edge content nodes 1150 may be used to execute other services and fulfill other workloads. The edge content nodes 1150 and other systems of the edge cloud 1000 are connected to a cloud or data center 1170, which uses a backhaul network 1160 to fulfill higher-latency requests from a cloud/data center for websites, applications, database servers, etc.

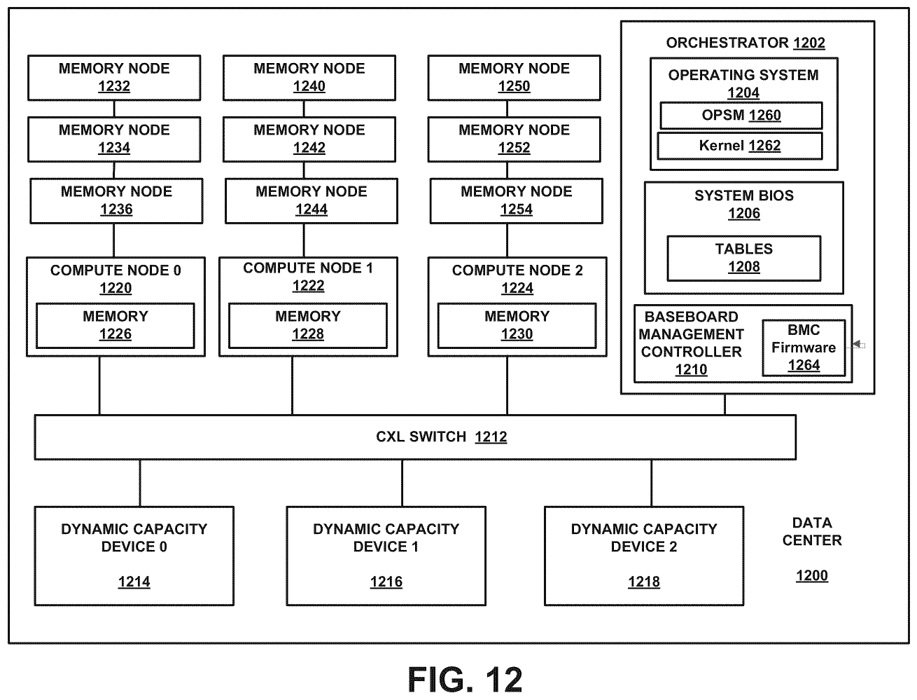

FIG. 12 is a block diagram of an embodiment of the system 910 described in conjunction with FIG. 9. In the embodiment shown in FIG. 12 the system is a data center 1200. The data center 1200 includes a plurality of communicatively coupled nodes that include three compute nodes (compute node 0 1220, compute node 1 1222 and compute node 3 1224) that communicate via CXL switch 1212. The data center 1200 also includes an orchestrator 1202 and dynamic capacity devices (dynamic capacity device 0 1214, dynamic capacity device 1 1216 and dynamic capacity device 2 1218) that also communicate via CXL switch 1212. In one embodiment the dynamic capacity devices can be storage nodes with volatile memory. In another embodiment the dynamic capacity devices can be storage nodes with non-volatile memory.

The CXL switch 1212 is a communications link that is based on the CXL standard. CXL is an open, standard interconnect based on the PCI Express (PCIe) 5.0 physical layer infrastructure that provides high-performance connectivity between one or more host processors and other devices. The CXL standard includes three protocols, CXL.io, CXL.cache and CXL.mem (CXL.memory). The compute nodes 1220, 1222, 1224 can use CXL memory (CXL.mem device) or can be coherent (CXL.cache). The CXL.mem protocol allows the compute nodes 1220, 1222, 1224 to directly access memory that is attached to other CXL devices in a cache-coherent manner. The CXL.cache protocol allows a connected device to cache data.

Each of the compute nodes 1220, 1222, 1224 are coupled to respective memory nodes. The memory nodes are CXL.mem devices. Compute node 0 1220 is coupled to memory node 1232, memory node 1234 and memory node 1236. Compute node 1 1222 is coupled to memory node 1240, memory node 1242 and memory node 1244. Compute node 2 1224 is coupled to memory node 1250, memory node 1252 and memory node 1254. Each of the compute nodes 1220, 1222, 1224 includes a local memory. Compute node 0 1220 includes local memory 1226. Compute node 1 1222 includes local memory 1228. Compute node 2 1224 includes local memory 1230.

The orchestrator 1202 includes an operating system (OS) 1204, a system Basic Input/Output System (BIOS) 1206 and a baseboard management controller (BMC) 1210. The system BIOS 1206 is firmware used to provide runtime services for the operating system (OS) 1204 and programs, and to perform hardware initialization during power-on startup of the data center 1200. The baseboard management controller 1210 manages the interface between system-management software and platform hardware.

The system BIOS 1206 includes tables 1208. In an embodiment, the tables 1208 are Advanced Configuration and Power Interface (ACPI) tables. ACPI is a standard that can be used by an operating system in a system to discover and configure computer hardware components, perform power management, auto configuration, and monitor status.

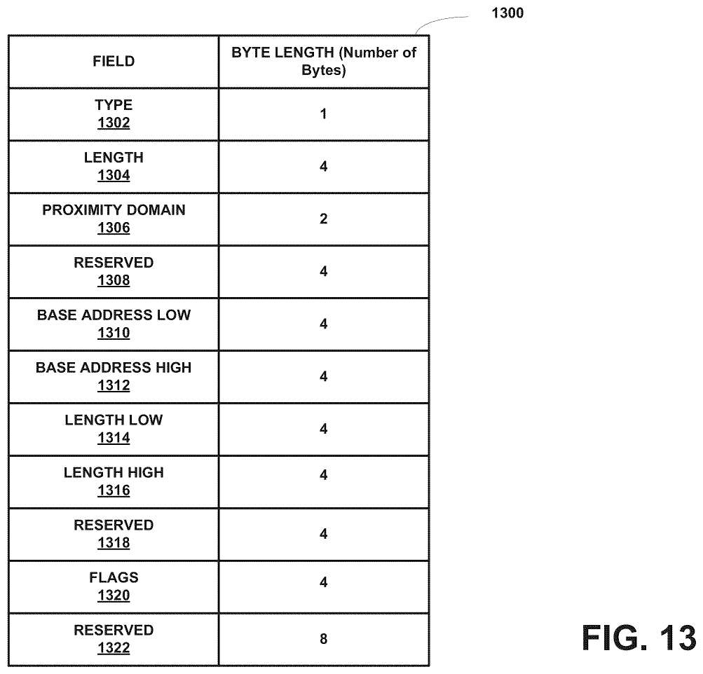

In an embodiment the tables 1208 include ACPI tables. The tables 1208 include an ACPI System Resource Affinity Table (SRAT) (that can also be referred to as a memory affinity structure). The SRAT provides memory topology information to the operating system. The topology information includes the association between a memory range and the proximity domain to which it belongs and information about whether the memory range can be hot-plugged. The system BIOS 1206 identifies a set of potential memory configurations for mapped memory ranges (for example, an alternate memory configuration for a mapped memory range) and populates the tables 1208. The SRAT will be described in conjunction with FIG. 13.

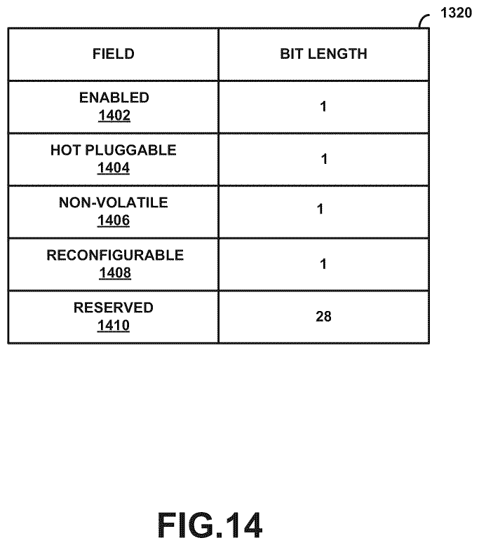

The tables 1208 also include an ACPI System Resource Affinity Table (SRAT) flags table that includes the definition of bits in a flags field in the ACPI System Resource Affinity Table (SRAT). The ACPI System Resource Affinity Table (SRAT) flags table will be described in conjunction with FIG. 14.

FIG. 13 illustrates an embodiment of a System Resource Affinity Table (SRAT) in an Advanced Configuration and Power Interface (ACPI) SRAT 1300 in tables 1208 in FIG. 12. The APCI SRAT 1300 includes a plurality of fields. Each field is one or more bytes. The number of bytes in each field is stored as a byte length.

A one byte type field 1302 identifies the ACPI SRAT 1300 to be a memory affinity structure.

The one byte length field 1304 stores 40, the number of bytes in the ACPI SRAT 1300.

The four byte proximity domain field 1306 stores a four byte integer that represents the proximity domain to which the memory range belongs.

The 4 byte base address low field 1310 stores the low 32 bits of the base address of the memory range.

The 4 byte base address high field 1312 stores the low 32 bits of the base address of the memory range.

The 4 byte length low field 1314 stores the low 32 bits of the length of the memory range.

The 4 byte length high field 1316 stores the high 32 bits of the length of the memory range.

The 4 byte flags field 1320 stores flags for the memory affinity structure. The flags indicate whether the region of memory defined in the System Resource Affinity Table (SRAT) is enabled and can be hot plugged. The flags field will be described later in conjunction with FIG. 14.

There are three reserved fields, a 2 byte reserved field 1308, a 4 byte reserved field 1318 and an 8 byte reserved field 1322.

FIG. 14 illustrates an embodiment of the flags field 1320 in the System Resource Affinity Table (SRAT) in the ACPI SRAT 1300 in FIG. 13.

The 1 bit enabled field 1402 allows system firmware to populate the System Resource Affinity Table (SRAT) in the ACPI SRAT 1300 with a static number of structures that can be enabled when required. If the enabled field 1402 is set to logic ‘0’, the OSPM ignores the contents of the Memory Affinity structure in the ACPI SRAT 1300.

The 1 bit hot pluggable field 1404 is used in conjunction with the 1 bit enabled field 1402. If the enabled field 1402 is set to logic ‘1’ and the 1 bit hot pluggable field 1404 is also set to logic ‘1’ the system hardware supports hot-add and hot remove of the memory region defined in the System Resource Affinity Table (SRAT) in the ACPI SRAT 1300. If the enabled field 1402 is set to logic ‘1’ and the 1 bit hot pluggable field 1404 is also cleared to logic ‘0’, the system hardware does not support hot-add or hot-remove. If the enabled field 1402 is cleared to logic ‘0’ and the 1 bit hot pluggable field 1404 is also cleared to logic ‘0’, the OSPM ignores the contents of the System Resource Affinity Table (SRAT) in the ACPI SRAT 1300.

The state of the 1 bit nonvolatile field 1406 indicates the type of system memory. If set to logic ‘1’, the system memory is non-volatile memory.

The state of the 1 bit reconfigurable field 1408 indicates if the memory region is supported by the system BIOS. If set to logic ‘1’, the memory region represents an alternate potential memory configuration supported by the system BIOS 1206.

The reserved field 1410 is a 28-bit field that is not used and is cleared to logic ‘0’

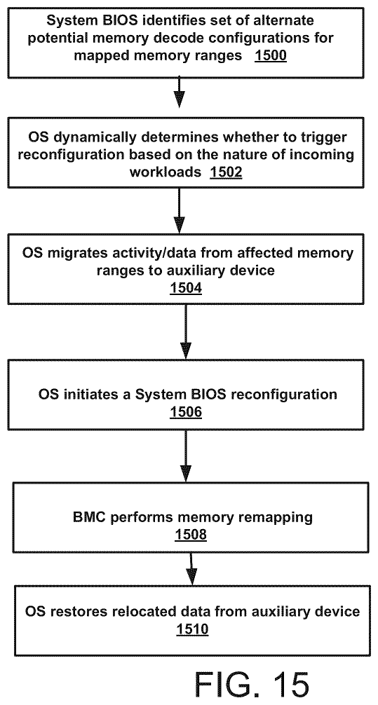

FIG. 15 is a flowgraph illustrating the use of the ACPI System Resource Affinity Table (SRAT) to offload reconfiguration of system memory to the OS 1204 with assistance from the system BIOS 1206.

At block 1500, at system powerup, the system BIOS 1206 identifies a set of alternate potential memory configurations for mapped memory ranges. The system BIOS 1206 populates the ACPI SRAT tables discussed in conjunction with FIG. 13 and FIG. 14 in tables 1208 to describe the memory configurations to the OS 1204 to allow the OS 1204 to read the mapped memory ranges stored in the tables 1208. Memory configurations include type of memory (for example, DRAM, CXL, HBM), number of memory devices, the configuration of the memory devices and how the memory is reported to the OS 1204.

In an embodiment, enumeration of alternate potential memory configurations is performed during every system powerup. The mapped memory range can be single level memory (1LM) using DRAM (for example, DDR5 DRAM) or CXL Volatile memory or can be two level memory (2LM) or CXL Persistent Memory (PMEM) or a combination of DRAM and PMEM.

The system BIOS 1206 creates additional Memory Affinity Structures in the System Resource Affinity Table (SRAT). The additional Memory Affinity Structures are programmed by the system BIOS 1206 to make them readable by the OS 1204. To create the additional Memory Affinity Structures, the system BIOS 1206 first identifies possible alternative memory configurations and then creates (augments) the SRAT to describe the alternative memory configurations.

The alternate memory configurations are identified via the flags field 1320 in the ACPI SRAT 1300. The Enabled field 1402 (bit 0) in the flags field 1320 is clear (cleared to logic ‘0’) and the Reconfigurable field 1408 (bit 3) in the flags field is set (set to logic ‘1’). An Operating System-directed Power Management (OSPM) 1260 in the OS 1204 does not ignore Memory Affinity Structures based solely on the state of the Enabled bit field. System BIOS 1206 also sets the Reconfigurable field 1408 for the Enabled ranges corresponding to the alternate decode configurations. The system BIOS 1206 creates additional structures in a Heterogenous Memory Attribute Table (HMAT) in tables 1208 to describe the alternate Memory Proximity Domains listed in the SRAT. The system BIOS 1206 creates additional entries in a System Local Information Table (SLIT) in tables 1208 to describe the alternate Memory Proximity Domains listed in the SRAT. The additional structures include performance information such as memory bandwidth and latency for the alternate proximity domains. Processing continues with block 1502.

At block 1502, during runtime, the OS determines if/when one or more of the alternate memory configurations described in the ACPI is advantageous to the kernel 1262. The OS 1204 prepares a list of Memory Proximity Domain Identifiers (IDs) of these configurations. The configurations are identified by the Proximity Domain.

The OS kernel is the agent responsible for scheduling jobs on the system and can determine when the load on the system is relatively low. The OS kernel can exploit this knowledge and choose to trigger memory reconfiguration during periods of low utilization, thereby, minimizing any performance overhead of this operation than would be otherwise possible. Upon determination to trigger a memory configuration, processing continues with block 1504.

At block 1504, the OS 1204 prepares to migrate all activity/data out of affected memory ranges. The affected memory ranges are memory ranges that are impacted by data loss by the reconfiguration process. To ensure that data stored in the affected memory ranges is not lost during the reconfiguration, the data is saved to another memory range prior to the start of the reconfiguration process. The OS 1204 identifies the operations to be performed to safely reconfigure memory from the BIOS-provided ACPI data in tables 1208 without losing any data. The OS 1204 suspends all memory accesses to the memory ranges that are being reconfigured that are associated with the affected memory ranges. The OS 1204 OS relocates all required data from affected memory ranges in one or more memory nodes (for example, memory nodes 1232, 1234, 1236) to an auxiliary device such as a CXL Dynamic Capacity Device (CXL DCD) (for example, Dynamic Capacity Device 1216). Processing continues with block 1506.

At block 1506, the OS 1204 initiates a system BIOS reconfiguration request to the memory configuration identified by the list of Memory Proximity Domain IDs selected by the OS 1204. The system BIOS 1206 uses a secure agent to compute and program the memory decode registers to enable the memory configuration identified by the selected memory proximity domain IDs. A secure agent is used because memory decoders are locked prior to OS boot so that malicious Ring 0 software (software with the highest privilege) cannot re-program the memory decode registers. Additionally, the secure agent ensures that the memory decoders are programmed to avoid security concerns (for example, memory aliasing).

In one embodiment, a System Management Mode (SMM) in compute node 0 1220, compute node 1 1222 and compute node 2 1224 is used to perform the memory reconfiguration. In another embodiment, the baseboard management controller (BMC) 1210 is used to perform the memory reconfiguration. When the OS 1204 requests the system BIOS 1206 to perform the remapping, a _DSM (ACPI Device Specific Method) is invoked in the system BIOS 1206. For example, the remapping can be to switch from a single level memory (a flat memory) to a two level memory (a hierarchical memory where a first level of memory acts as a cache to a second level of memory). Processing continues with block 1508.

At block 1508, the system BIOS 1206 via the DSM passes the request to perform remapping to the baseboard management controller 1210 to reprogram a system address map in compute node 0 1220, compute node 1 1222 and compute node 2 1224. In response to receiving the request to perform remapping, the memory remapping is performed by Baseboard Management Controller (BMC) firmware 1264 in the BMC by reprograming the system address map accordingly. Control passes back to the OS 1204 after the system address map has been reprogrammed by the BMC firmware 1264. Processing continues with block 1510.

At block 1510, the OS restores all of the relocated data from the auxiliary device (for example, CXL DCD ((for example, Dynamic Capacity Device 1216) to the newly configured DDR memory ranges (for example, the relocated data stored in Dynamic Capacity Device 1216 can be restored to the newly configured DDR memory ranges in memory node 1250, memory node 1252 and memory node 1254). Subsequently, the OS 1204 restarts all suspended activity and continues execution in the new memory configuration.

The use of the ACPI System Resource Affinity Table (SRAT) described in conjunction with FIG. 15 to offload reconfiguration of system memory to the operating system with assistance from platform/firmware provides the ability for the OS 1204 to adapt platform memory configuration to the dynamically changing workload conditions in the data center in an architecture-agnostic manner. For example, if the nature of incoming workloads changes over time, the kernel can reconfigure memory to extract better performance from existing resources. Avoiding Reboot improves CSP server uptime requirements and reduces manual intervention by an operator.

An embodiment has been described for reconfiguration of system memory in a data server. In other embodiments, Input/Output (I/O) devices or accelerator devices can be reconfigured.

It is envisioned that aspects of the embodiments herein can be implemented in various types of computing and networking equipment, such as switches, routers and blade servers such as those employed in a data center and/or server farm environment. Typically, the servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities can typically employ large data centers with a multitude of servers.

Each blade comprises a separate computing platform that is configured to perform server-type functions, that is, a “server on a card.” Accordingly, each blade includes components common to conventional servers, including a main printed circuit board (main board) providing internal wiring (i.e., buses) for coupling appropriate integrated circuits (ICs) and other components mounted to the board. These components can include the components discussed earlier in conjunction with FIG. 1.

Flow diagrams as illustrated herein provide examples of sequences of various process actions. The flow diagrams can indicate operations to be executed by a software or firmware routine, as well as physical operations. In one embodiment, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

To the extent various operations or functions are described herein, they can be described or defined as software code, instructions, configuration, and/or data. The content can be directly executable (“object” or “executable” form), source code, or difference code (“delta” or “patch” code). The software content of the embodiments described herein can be provided via an article of manufacture with the content stored thereon, or via a method of operating a communication interface to send data via the communication interface. A non-transitory machine readable storage medium (computer-readable store media) can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to the disclosed embodiments and implementations of the invention without departing from their scope.

Therefore, the illustrations and examples herein should be construed in an illustrative, and not a restrictive sense. The scope of the invention should be measured solely by reference to the claims that follow.

### Examples

Illustrative examples of the technologies disclosed herein are provided below. An embodiment of the technologies may include any one or more, and any combination of, the examples described below.

Example 1 is an orchestrator comprising circuitry. The circuitry to store an alternate memory configuration for a mapped memory range, upon a determination to trigger a memory reconfiguration, migrate data from the mapped memory range to an auxiliary device. The circuitry to perform memory remapping for the alternate memory configuration and restore the data from the auxiliary device to the mapped memory range.

Example 2 includes the orchestrator of Example 1, optionally the alternate memory configuration is stored in a table in system Basic Input/Output System (BIOS).

Example 3 includes the orchestrator of Example 1, optionally the memory remapping is performed by Baseboard Management Controller (BMC) firmware.

Example 4 includes the orchestrator of Example 1, optionally the auxiliary device is a Dynamic Capacity Device.

Example 5 includes the orchestrator of Example 4, optionally the Dynamic Capacity Device is a volatile memory.

Example 6 includes the orchestrator of Example 1, optionally the mapped memory range is a region of memory defined in a System Resource Affinity Table.

Example 7 includes the orchestrator of Example 4, optionally the Dynamic Capacity Device is a CXL.mem device.

Example 8 is a system comprising an auxiliary device and circuitry. The circuitry to store an alternate memory configuration for a mapped memory range, upon a determination to trigger a memory reconfiguration, migrate data from the mapped memory range to the auxiliary device. The circuitry to perform memory remapping for the alternate memory configuration and restore the data from the auxiliary device to the mapped memory range.

Example 9 includes the system of Example 8, optionally alternate memory configuration is stored in a table in system Basic Input/Output System (BIOS).

Example 10 includes the system of Example 8, optionally the memory remapping is performed by Baseboard Management Controller (BMC) firmware.

Example 11 includes the system of Example 8, optionally the auxiliary device is a Dynamic Capacity Device.

Example 12 includes the system of Example 11, optionally the Dynamic Capacity Device is a volatile memory.

Example 13 includes the system of Example 8, optionally the mapped memory range is a region of memory defined in a System Resource Affinity Table.

Example 14 includes the system of Example 11, optionally the Dynamic Capacity Device is a CXL.mem device.

Example 15 is a method comprising storing an alternate memory configuration for a mapped memory range. The method also includes upon a determination to trigger a memory reconfiguration, migrating data from the mapped memory range to an auxiliary device. The method also includes performing memory remapping for the alternate memory configuration. The method also includes restoring the data from the auxiliary device to the mapped memory range.

Example 16 includes the method of Example 15, optionally the alternate memory configuration is stored in a table in system Basic Input/Output System (BIOS).

Example 17 includes the method of Example 15, optionally the memory remapping is performed by Baseboard Management Controller (BMC) firmware.

Example 18 includes the method of Example 15, optionally the auxiliary device is a Dynamic Capacity Device.

Example 19 includes the method of Example 15, optionally the mapped memory range is a region of memory defined in a System Resource Affinity Table.

Example 20 includes the method of Example 18, optionally the Dynamic Capacity Device is a CXL.mem device.

Example 21 is at least one machine readable medium that includes a plurality of instructions that in response to being executed by a system can cause the system to carry out a method according to any one of examples 15 to 20.

Example 22 is an apparatus that includes means for performing the methods of any one of examples 15 to 20.

What is claimed is:

1. An orchestrator comprising:
circuitry to:
store an alternate memory configuration for a mapped memory range;
upon a determination to trigger a memory reconfiguration, migrate data from the mapped memory range to an auxiliary device;
perform memory remapping for the alternate memory configuration; and
restore the data from the auxiliary device to the mapped memory range.

2. The orchestrator of claim 1, wherein the alternate memory configuration is stored in a table in system Basic Input/Output System (BIOS).

3. The orchestrator of claim 1, wherein the memory remapping is performed by Baseboard Management Controller (BMC) firmware.

4. The orchestrator of claim 1, wherein the auxiliary device is a Dynamic Capacity Device.

5. The orchestrator of claim 4, wherein the Dynamic Capacity Device is a volatile memory.

6. The orchestrator of claim 1, wherein the mapped memory range is a region of memory defined in a System Resource Affinity Table.

7. The orchestrator of claim 4, wherein the Dynamic Capacity Device is a CXL.mem device.

8. A system comprising:
an auxiliary device; and
circuitry to:
store an alternate memory configuration for a mapped memory range;
upon a determination to trigger a memory reconfiguration, migrate data from the mapped memory range to the auxiliary device;
perform memory remapping for the alternate memory configuration; and
restore the data from the auxiliary device to the mapped memory range.

9. The system of claim 8, wherein the alternate memory configuration is stored in a table in system Basic Input/Output System (BIOS).

10. The system of claim 8, wherein the memory remapping is performed by Baseboard Management Controller (BMC) firmware.

11. The system of claim 8, wherein the auxiliary device is a Dynamic Capacity Device.

12. The system of claim 11, wherein the Dynamic Capacity Device is a volatile memory.

13. The system of claim 8, wherein the mapped memory range is a region of memory defined in a System Resource Affinity Table.

14. The system of claim 11, wherein the Dynamic Capacity Device is a CXL.mem device.

15. A method comprising:
storing an alternate memory configuration for a mapped memory range;
upon a determination to trigger a memory reconfiguration, migrating data from the mapped memory range to an auxiliary device;
performing memory remapping for the alternate memory configuration; and
restoring the data from the auxiliary device to the mapped memory range.

16. The method of claim 15, wherein the alternate memory configuration is stored in a table in system Basic Input/Output System (BIOS).

17. The method of claim 15, wherein the memory remapping is performed by Baseboard Management Controller (BMC) firmware.

18. The method of claim 15, wherein the auxiliary device is a Dynamic Capacity Device.

19. The method of claim 15, wherein the mapped memory range is a region of memory defined in a System Resource Affinity Table.

20. The method of claim 18, wherein the Dynamic Capacity Device is a CXL.mem device.
